(19) United States
(12) Patent Application Publication
(10) Pub. No.: US 2026/0341763 A1
(43) Pub. Date: Oct. 29, 2026

(54) METHOD FOR OPERATING A FUEL CELL SYSTEM

(71) Applicant: Robert Bosch GmbH, Stuttgart (DE)

(72) Inventors: Jonas Breitinger, Stuttgart (DE); Mark Hellmann, Korntal (DE)

(21) Appl. No.: 19/103,685

(22) PCT Filed: Aug. 10, 2023
(86) PCT No.: PCT/EP2023/072130

§ 371 Date: Feb. 13, 2025

(30) Foreign Application Priority Data
Aug. 16, 2022 (DE) 10 2022 208 491.8

(51) Int. Cl. H01M 8/04992; H01M 8/04111; H01M 8/0438; H01M 8/04492; H01M 8/04746; H01M 8/10

(52) U.S. Cl. CPC H01M 8/04992; H01M 8/04111; H01M 8/04432; H01M 8/04529; H01M 8/04753; H01M 2008/1095; H01M 2250/20

(57) ABSTRACT

A method for operating a fuel cell system (2), comprising the steps of sensing (100) data to determine a current membrane wetting of the fuel cell system (2) by means of a sensor unit (20), determining (200) the current membrane wetting of the fuel cell system (2) by means of a processing unit (22) based on the sensed data, as well as adjusting (400) of at least one of the target parameters of an overall pressure (P_{Over}) of a cathode gas and a stoichiometry (λ) of the cathode gas in a targeted manner based on the determined current membrane wetting using a control unit (24).

### BACKGROUND

The present invention proceeds from a method of operating a fuel cell system, a fuel cell system, and a motor vehicle comprising such a fuel cell system.

Hydrogen-based fuel cell systems are considered to be the mobility concept of the future, because they only emit water as exhaust gas and enable fast fueling times. However, there is still room for improvement in terms of the efficiency and service life of fuel cell systems.

Thus, in fuel cell systems, there may be contradictions between stack requirements and subsystem limits. This problem exists primarily when a subsystem is to be designed for different stacks with different requirements. However, even with a targeted adjustment of the subsystems to the respective stack which make use of their large operating range (e.g. 5-100% oxygen consumption and corresponding air flow rates, pressures between 1 and >3 bar), discrepancies can occur at individual operating points between the stack request and the subsystem limits. Such discrepancies as those above may in particular lead to too much or too little membrane wetting, which not only significantly reduces the attainable performance of a fuel cell system, but also leads to irreversible damage to the fuel cell system.

### SUMMARY

The object of the invention according to a first aspect is a method with the features of the independent method claim and, according to a second aspect, a fuel cell system with the features of the independent system claim. Further features and details of the invention arise from the respective dependent claims, the description, and the drawings. In this context, features and details described in connection with the method according to the invention clearly also apply in connection with the fuel cell system according to the invention, and respectively vice versa, so that mutual reference to the individual considerations of the invention always is or can be made with respect to the disclosure.

The method according to the invention or the fuel cell system according to the invention serves in particular to compensate for excessive drying as well as excessive wetting of the membranes of fuel cells of a fuel cell system in operation, and thus serves to reliably avoid irreversible damage by reactant depletion as a result of flooding of the membranes or as a result of excessive drying of the membranes. This can not only improve the efficiency and reliability of a fuel cell system, but also significantly extend the service life of a fuel cell system. The above-mentioned advantages are also achieved in a cost-efficient manner and using a simple design via the specific embodiment of the method or fuel cell system according to the invention. Through to the configuration provided according to the invention, the method according to the invention can also be integrated into existing fuel cell systems in a simple and cost-efficient manner.

The method according to the invention for operating a fuel cell system comprises the steps of sensing data for determining a current membrane wetting of a fuel cell system by means of a sensor unit, determining the current membrane wetting of the fuel cell system using a processing unit via a sensor unit based on the acquired data, as well as a adjusting at least one of the target parameters of an overall pressure of a cathode gas and a stoichiometry of the cathode gas in a targeted manner based on the determined current membrane wetting. Of course, both of the above-mentioned target parameters can also be adjusted in a targeted manner (simultaneously or sequentially).

Current membrane wetting in the context of the invention can in particular be understood to mean the current water content of the membranes of the fuel cells of the fuel cell system in question, which must not be too low, but also not too high, in order to enable the most effective and long-lasting operation of the fuel cell system as possible. According to the present invention, an overall pressure of a cathode gas can be understood to mean in particular the cathode outlet pressure measurable at the cathode outlet, which can in particular be variable depending on the amount of an air supply. The stoichiometry of the cathode gas may preferably be understood to mean the reciprocal value of the conversion of the cathode gas in the fuel cell reaction. Preferably, the cathode gas is supplied in a superstoichiometric manner, wherein the stoichiometry can in particular be between 1 and 4.

The method according to the invention can be used in particular in fuel cell-powered motor vehicles. However, it is also conceivable to use the method in other fuel cell-powered transportation means, such as cranes, ships, rail vehicles, flying objects, or even in stationary fuel cell-powered objects. The method according to the invention can in particular be used for PEM fuel cells, or the fuel cell system according to the invention is preferably configured as a PEM fuel cell system.

In the context of the invention, it has in particular been recognized that in order to ensure efficient and system-friendly operation of a fuel cell system, it is not sufficient to associate any current strength and temperature under predetermined target activity to a combination of target parameters, such as a cathode outlet pressure and/or a cathode stoichiometry in stationary operational strategies to ensure sufficient membrane wetting. Rather, it has been recognized that if target parameters such as a cathode outlet pressure and/or a cathode stoichiometry cannot be optimally adjusted, e.g. due to system limitations, a deviation from optimal exit activity occurs. Thus, if the pressure is too high, there is a risk of excessively wet operation with a risk of flooding. If the pressure is too low, there is also a risk of excessively dry operation and drying of the membrane. Likewise, too high a cathode stoichiometry may result in excessively dry operation and drying of the membrane, whereas too low a cathode stoichiometry may result in excessively wet operation and a risk of flooding.

According to the present invention, in order to ensure a simple design and at the same time exact determination of a current membrane wetting of a fuel cell system, in particular it can be provided that current membrane wetting in the fuel cell system is determined by determining a current exit activity at a cathode outlet of the fuel cell system, wherein the targeted adjustment of at least one of the target parameters of an overall pressure of a cathode gas and a stoichiometry of the cathode gas is carried out preferably based on a comparison of the current exit activity at the cathode outlet of the fuel cell system with at least one threshold for exit activity at the cathode outlet of the fuel cell system. Preferably, at least two limit values or limit value profiles are used, one for a minimum exit activity at a given current strength and temperature and one for a maximum exit activity at a given current strength and temperature.

The current exit activity should lie between these limit values or limit value curves so that no targeted adjustment should be made to at least one of the target parameters of an overall pressure of a cathode gas and a stoichiometry of the cathode gas. However, if the current exit activity does not fall within the range, an adjustment should be made.

According to the present invention, it can advantageously be provided, in order to ensure the most economical operation of the fuel cell system as possible, that at least one of the target parameters of an overall pressure of a cathode gas and a stoichiometry of the cathode gas is adjusted in a targeted manner while taking into account a minimization of the performance of a compressor for compressing the cathode gas.

According to the present invention, in the framework of determining a current membrane wetting of a fuel cell system as accurately as possible and thus preventing inefficient and system-damaging operation of a fuel cell system as reliably as possible, it can be provided that data is additionally captured in order to determine a current oxygen partial pressure at a cathode outlet of the fuel cell system by means of a sensor unit and that, based on the sensed data, the current oxygen partial pressure at the cathode outlet of the fuel cell system is determined by means of a processing unit, wherein the targeted adjustment of at least one of the target parameters of an overall pressure of a cathode gas and a stoichiometry of the cathode gas is carried out using the control unit, preferably additionally based on the determined current oxygen partial pressure at the cathode outlet of the fuel cell system. Of course, the sensor unit and/or processing unit in question may also be the same as that previously described with regard to sensing parameters or determining the current membrane wetting. It is also conceivable, for example, that the targeted adjustment of at least one of the target parameters of an overall pressure of a cathode gas and a stoichiometry of the cathode gas (in particular in a stationary operation) is preferably additionally carried out based on further variables, such as a minimum speed of a cathode gas for a liquid water discharge or the like.

In the context of a method for operating a fuel cell as economically as possible, it may further be provided according to the invention that, prior to the targeted adjustment of at least one of the target parameters of an overall pressure of a cathode gas and a stoichiometry of the cathode gas based on the determined current membrane wetting, the current membrane wetting and/or a current oxygen partial pressure is evaluated, wherein the current membrane wetting and/or the current oxygen partial pressure is preferably evaluated to determine the amount of deviation from a threshold value for membrane wetting and/or a current oxygen partial pressure and/or with respect to the current state of a fuel cell system and/or with respect to an area of application of the fuel cell system. Based on an advantageously provided evaluation, it is possible to only have to make an adjustment if it is actually necessary. If the deviation of the value of membrane wetting is still acceptable or the system is not yet old, no direct intervention is required in the case of a minor deviation.

With regard to the possibility of targeted compensation for subsystem limitations, it may further be provided in the present invention that, prior to the targeted adjustment of at least one of the target parameters of an overall pressure of a cathode gas and a stoichiometry of the cathode gas based on the determined current membrane wetting, the current membrane wetting and/or a current oxygen partial pressure may be evaluated, wherein the evaluation is preferably carried out in view of a limitation of the adaptability of one of the target parameters of an overall pressure of a cathode gas and a stoichiometry of the cathode gas, wherein, based on the evaluation, the overall pressure of a cathode gas or the stoichiometry of the cathode gas is adjusted in particular to compensate for the limitation of the adaptability of the respective other component. A possible subsystem limitation may be, for example, the minimum or maximum available air flow rate, which can be limited, for example, by the pumping limit of the compressor, which can either not be able to be adjusted low enough or not be able to be adjusted high enough. Thus, for example, too little exit activity can occur already with the adjustable minimum flow rate of the air system without additional correction of the pressure, so that excessively dry membrane conditions can occur. If such a subsystem limitation is detected in the context of an evaluation provided advantageously according to the invention, the limitation of the adaptability of the one component (cathode stoichiometry) can be compensated for by a targeted adjustment of the other component (total pressure) so that a desired activity or membrane wetting is still maintained. A possible subsystem limitation can also be the maximum achievable minimum pressure, without the adjustment of which very wet membrane conditions can result up to membrane flooding. With a targeted adjustment of the stoichiometry of the cathode gas, the desired target wetting or targeted membrane wetting can be set despite the pressure limitation. Further variations for possible limitations in the air system may include a minimum and/or maximum compressor speed, a maximum electric power output of a compressor, and a maximum temperature of a compressor impeller.

In the context of a simple, preferably automatically controllable method for operating a fuel cell system, it can be advantageously further provided according to the invention that the method is carried out as a self-learning method wherein, in the context of carrying it out in a self-learning fashion, age-related changes can preferably be compensated for after an initial learning phase. Advantageously, it can be provided in this context that the age-related changes can relate to changing pressure losses of components, changing operating limits, a restart after repair or replacement of components.

In the context of the invention, it may also advantageously be provided that individual, several or all obligatory and/or optional steps of the method according to the invention can be carried out in the proposed order, as well as in deviation from the proposed order. In this case, individual, several or all mandatory and/or optional steps of the method according to the invention may be repeated, for example repeated cyclically.

Furthermore, of course, individual, multiple, or all of the mandatory and optional steps of the method according to the invention may also be implemented by a computer.

The subject matter of the invention also includes a fuel cell system, in particular for carrying out a method described above. The fuel cell system according to the invention comprises an anode path comprising an anode, an anode gas supply line, and an anode gas return line comprising a cathode path, a cathode, a
cathode gas supply line and a cathode gas discharge line, a sensor unit for sensing data to determine a current membrane wetting of the fuel cell system, a processing unit for determining the current membrane wetting of the fuel cell system, and a control unit for targeted adjustment of at least one of the target parameters of an overall pressure of a cathode gas and a stoichiometry of the cathode gas. Thus, the fuel cell system has the same advantages as have already been described in detail in relation to the method according to the invention.

In order to ensure a quick way to precisely adjust a target parameter in a targeted manner and using a simple design, it can advantageously be provided in this context that a valve and a compressor are provided for the targeted adjustment of at least one of the target parameters of an overall pressure of a cathode gas and a stoichiometry of the cathode gas.

In order to ensure a simple, preferably automatable control of the fuel cell system according to the invention, it may further be provided in this context that the fuel cell system is configured in the form of a self-learning system. The self-learning system can, for example, be configured to learn from a logic and independently enter setpoints or target values, and in this way improve subsystem control. For example, the fuel cell system can be equipped with an initial set of target variables. In a first phase, the fuel cell system can derive a new target value specification, for example at the initial start, starting from an initial configuration using a reactive control path, especially taking into account the currently occurring subsystem limits. The new setpoints may then preferably be fed back and used as a data input for self-learning optimization. In a second phase, the fuel cell system may then preferably improve with each operation until an optimal level is achieved. In a third phase (over the life of the system), the frequency at which setpoints are changed can then preferably significantly decrease and be carried out, for example only once a month. If the fuel cell system is changed in a relevant manner during major maintenance (e.g. replacement/exchange of components), re-initialization and learning may be carried out.

The subject matter of the invention also includes a motor vehicle comprising a fuel cell system described above. Thus, the motor vehicle according to the invention has the same advantages as have already been described in detail in relation to the method according to the invention and the fuel cell system according to the invention.

### BRIEF DESCRIPTION OF THE DRAWINGS

Further advantages, features, and details of the invention arise from the following description, in which exemplary embodiments of the invention are described in detail with reference to the drawings. In this context, the features mentioned in the claims and in the description can each be essential to the invention individually or in any combination.

Shown are:

FIG. 1 a schematic illustration of the individual steps of a method according to the invention for operating a fuel cell system,

FIG. 2 a schematic representation of a fuel cell system according to the invention according to a first exemplary embodiment,

FIG. 3 a further schematic representation of individual steps of the method according to the invention for operating a fuel cell system in the context of a self-learning design.

### DETAILED DESCRIPTION

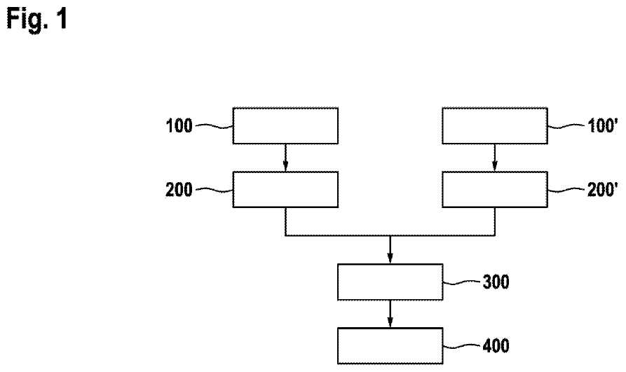

FIG. 1 shows a schematic representation of the individual steps of a method according to the invention for operating a fuel cell system 2.

As can be seen from FIG. 1, the method according to the invention comprises the steps of sensing 100 data for determining a current membrane wetting of a fuel cell system 2 by means of a sensor unit 20, determining 200 the current membrane wetting of the fuel cell system 2 by means of a processing unit 22 based on the sensed data, as well as adjusting 400 at least one of the target parameters of an overall pressure P_{Over} of a cathode gas and a stoichiometry λ of the cathode gas in a targeted manner based on the determined current membrane wetting by means of a control unit 24.

It may advantageously be provided that the determination 200 of the current membrane wetting of the fuel cell system 2 is carried out by determining a current exit activity a at a cathode outlet 42 of the fuel cell system 2, wherein the targeted adjustment 400 of at least one of the target parameters of an overall pressure P_{Over} of a cathode gas and a stoichiometry λ of the cathode gas occurs, preferably based on a comparison of the current exit activity a at the cathode outlet 42 of the fuel cell system 2 with at least one limit value for exit activity a at the cathode outlet 42 of the fuel cell system 2.

According to the present exemplary embodiment of a method according to the invention for operating a fuel cell system 2, it is further provided that the targeted adjustment 400 of at least one of the target parameters of an overall pressure P_{Over} of a cathode gas and a stoichiometry λ of the cathode gas is carried out taking into account a minimization of the performance of a compressor 36 for the compression of the cathode gas.

Furthermore, according to the present exemplary embodiment of a method according to the invention for operating a fuel cell system 2 it may be provided that additionally, data be sensed 100′ to determine a current oxygen partial pressure pO₂ at a cathode outlet 42 of the fuel cell system 2 by means of a sensor unit 20′ (or the sensor unit 20) and the current oxygen partial pressure pO₂ at the cathode outlet 42 of the fuel cell system 2 be determined 200′ by means of a processing unit 22′ (or the processing unit 22), wherein the targeted adjustment 400 of at least one of the target parameters of an overall pressure P_{Over} of a cathode gas and a stoichiometry λ of the cathode gas may be performed additionally based on the determined current oxygen partial pressure pO₂ at the cathode outlet 42 of the fuel cell system 2 by means of the control unit 24.

Also, it may be further contemplated that, prior to the targeted adjustment 400 of at least one of the target parameters of an overall pressure P_{Over} of a cathode gas and a stoichiometry λ of the cathode gas based on the determined current membrane wetting, an evaluation 300 of the current membrane wetting and/or a current oxygen partial pressure pO₂ is carried out, wherein the evaluation 300 is preferably performed with regard to a limitation of the adjustability of one of the target parameters of an overall pressure P_{Over} of a cathode gas and a stoichiometry of the cathode gas, wherein, in particular, a targeted adjustment of the total pressure P_{Tot} of a cathode gas or the stoichiometry λ of the cathode gas is carried out based on the evaluation 300 to compensate for the limitation of the adjustability of the respective other component.

Finally, it may further be contemplated that the method will be self-learning, wherein preferably age-related changes will be able to be compensated for in the context of the self-learning embodiment after an initial learning phase.

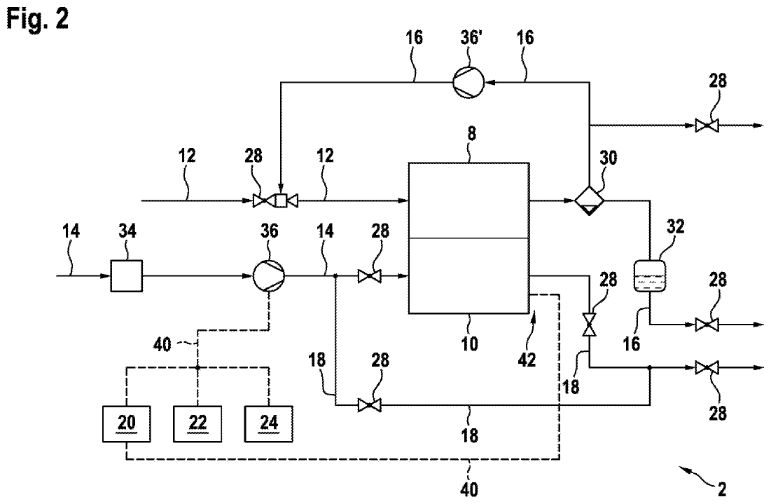

FIG. 2 shows a schematic representation of a fuel cell system 2 according to the invention according to a first exemplary embodiment.

As can be seen in FIG. 2, the fuel cell system 2 according to the invention comprises an anode path comprising an anode 8, an anode gas supply line 12 and an anode gas return or discharge line 16, a cathode path comprising a cathode 10, a cathode gas supply line 14 and a cathode gas discharge line 18, a sensor unit 20 for sensing 100 data for determining a current membrane wetting of the fuel cell system 2, a processing unit 22 for determining 200 the current membrane wetting of the fuel cell system 2 and a control unit 24 for the targeted adjustment of at least one of the target parameters of an overall pressure of a cathode gas and a stoichiometry of the cathode gas.

To control the flow of gas, the fuel cell system 2 comprises different valves 28.

In order to complete a targeted adjustment of at least one of the target parameters of an overall pressure of a cathode gas and a stoichiometry of the cathode gas, the sensor unit 22, the processing unit 24 and the control unit 26 may be connected to each other and to the compressor 36 via a control cable 40 or wirelessly.

To sense 100 data to determine a current membrane wetting of the fuel cell system 2, the sensor unit 20 can also preferably be connected to cathode outlet 42.

Further, it can be seen that a water trap 30 is disposed to trap water in the anode gas return line 16 connected to a water tank 32 to store trapped water.

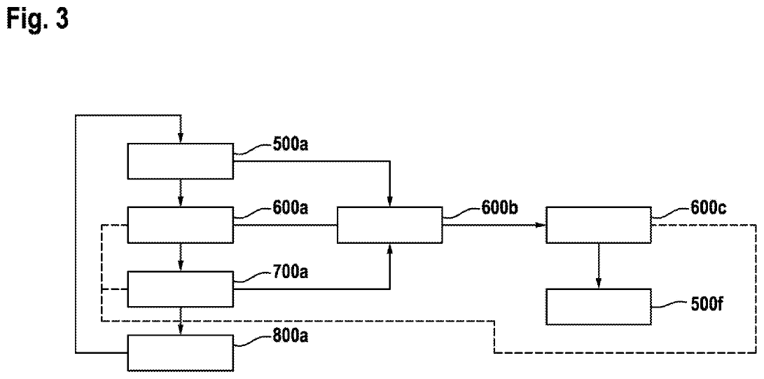

FIG. 3 shows a further schematic representation of individual steps of the method according to the invention for operating a fuel cell system 2 in the context of a self-learning embodiment.

As can be seen in FIG. 3, the method according to the invention comprises in a first phase, starting from a first start, first an initial configuration 500a, preferably taking into account currently occurring subsystem limits, wherein new target values are used as data input for a subsequent self-learning optimization.

In a second phase, the fuel cell system may then preferably improve with each operation until an optimal level is achieved. Optimization is carried out based on the new target values 600a, followed by an adjustment of the target variables 600b and feeding back the new target values 600c, which can be stored as part of a subsystem control 500f.

In a third phase (over the life of the system), the frequency at which the target values 700a are changed can then preferably be significantly decreased and performed, for example, only once a month.

If the fuel cell system is changed in a relevant manner during major maintenance (e.g., when replacing/exchanging components), re-initialization and learning 800a may be performed.

1. A method for operating a fuel cell system (2), the method comprising:
sensing (100) data to determine a current membrane wetting of a fuel cell system (2) by means of a sensor unit (20),
determining (200) the current membrane wetting of the fuel cell system (2) by means of a processing unit (22) based on the sensed data,
adjusting in a targeted manner (400) at least one of the target parameters of a total pressure (P_{Over}) of a cathode gas and a stoichiometry (λ) of the cathode gas based on the determined current membrane wetting by means of a control unit (24).

2. The method according to claim 1,
wherein
the determination (200) of the current membrane wetting of the fuel cell system (2) is carried out via a determination of a current exit activity (a) at a cathode outlet (42) of the fuel cell system (2), wherein the targeted adjustment (400) of at least one of the target parameters of an overall pressure (P_{Over}) of a cathode gas and a stoichiometry (λ) of the cathode gas is carried out based on a comparison of the current exit activity (a) at the cathode outlet (42) of the fuel cell system (2) with at least one threshold value for the exit activity (a) at the cathode outlet (42) of the fuel cell system (2).

3. The method according to claim 1,
wherein
the targeted adjustment (400) of at least one of the target parameters of an overall pressure (P_{Over}) of a cathode gas and a stoichiometry (λ) of the cathode gas is carried out taking into account a minimization of the performance of a compressor for compressing the cathode gas.

4. The method according to claim 1,
wherein
in addition, data is sensed (100′) for determining a current oxygen partial pressure (pO₂) at a cathode outlet (42) of the fuel cell system (2) by means of a sensor unit (20′) and the current oxygen partial pressure (pO₂) at the cathode outlet (42) of the fuel cell system (2) is determined (200′) by means of a processing unit (22′), wherein the targeted adjustment (400) of at least one of the target parameters of an overall pressure (P_{Over}) of a cathode gas and a stoichiometry (λ) of the cathode gas is carried out additionally based on the determined current oxygen partial pressure (pO₂) at the cathode outlet (42) of the fuel cell system (2) by means of the control unit (24).

5. The method according to claim 1,
wherein
prior to the targeted adjustment (400), at least one of the target parameters of an overall pressure (P_{Over}) of a cathode gas and a stoichiometry (λ) of the cathode gas are evaluated (300) based on the determined current membrane wetting and/or a current oxygen partial pressure (pO₂), wherein the evaluation (300) of the current
membrane wetting and/or the current oxygen partial pressure (pO₂) is carried out with regard to the amount of deviation from a limit value for membrane wetting and/or a current oxygen partial pressure (pO₂) and/or with respect to the current state of a fuel cell system (2) and/or with respect to an area of application of the fuel cell system (2).

6. The method according to claim 1,
wherein
prior to the targeted adjustment (400), at least one of the target parameters of an overall pressure (P_{Over}) of a cathode gas and a stoichiometry (λ) of the cathode gas are evaluated (300) based on the determined current membrane wetting
and/or a current oxygen partial pressure (pO₂), wherein the evaluation (300) is carried out with regard to a limitation of the adaptability of one of the target parameters of an overall pressure (P_{Over}) of a cathode gas and a stoichiometry (λ) of the cathode gas, wherein based on the evaluation (300)
a targeted adjustment of the total pressure (P_{Over}) of a cathode gas or the stoichiometry (λ) of the cathode gas is carried out to compensate for the limitation of the adaptability of the respective other component.

7. The method according to claim 1,
wherein
the method is carried out as a self-learning method, wherein age-related changes are compensated for in the context of the self-learning execution after an initial learning phase.

8. A fuel cell system (2), for performing a method according to claim 1, comprising:
an anode path comprising an anode (8), an anode gas supply line (12), and an anode gas return line (16),
a cathode path comprising a cathode (10), a cathode gas supply line (14), and a cathode gas discharge line (18),
a sensor unit (20) for sensing (100) data for determining a current membrane wetting of the fuel cell system (2),
a processing unit (22) for determining (200) the current membrane wetting of the fuel cell system (2),
a control unit (24) for targeted adjustment (400) of at least one of the target parameters of an overall pressure (P_{Over}) of a cathode gas and a stoichiometry (λ) of the cathode gas.

9. The fuel cell system (2) according to claim 8,
wherein
a valve (28) and a compressor (36) are provided for the targeted adjustment (400) of at least one of the target parameters of an overall pressure (P_{Over}) of a cathode gas and a stoichiometry (λ) of the cathode gas.

10. A fuel cell system (2) according to claim 8,
wherein
the fuel cell system (2) is configured in the form of a self-learning system.

11. A motor vehicle comprising a fuel cell system (2) according to claim 8.
